(19) United States
(12) Patent Application Publication
(10) Pub. No.: US 2020/0060313 A1
(43) Pub. Date: Feb. 27, 2020

(54) Method For Treating a Sickness

(71) Applicant: Issam Elder, Brooklyn, NY (US)

(72) Inventor: Issam Elder, Brooklyn, NY (US)

(21) Appl. No.: 16/542,443

(22) Filed: Aug. 16, 2019

Related U.S. Application Data
(60) Provisional application No. 62/721,620, filed on Aug. 23, 2018.

(51) Int. Cl. A23L 2/52

(52) U.S. Cl. CPC A23L 2/52; A23V 2002/00

(57) ABSTRACT

A method of treating sickness is disclosed. The method comprising: providing saffron powder, date seed powder, olive oil, black seeds oil, hemp oil, pure honey, ginger powder, Arabic gum and sesame paste; mixing the saffron powder, date seed powder, olive oil, black seeds oil, hemp oil, pure honey, ginger powder, Arabic gum and sesame paste to form a first mixture; settling the first mixture for a plurality of days; mixing the first mixture to form a second mixture; and pouring the second mixture into a container.

### CROSS REFERENCE TO RELATED APPLICATION

This non-provisional patent application claims priority to a U.S. Provisional Patent Application Ser. No. 62/721, 620 filed on Aug. 23, 2018 which is incorporated herein by reference.

### FIELD OF THE INVENTION

The present invention relates to a solution for treating a sickness. More particularly, this invention provides a process for making a solution for treating a sickness.

### BACKGROUND OF THE INVENTION

Generally, people become sick because of cold, sneezing, coughing or some other is kind of sickness. Also, people may have allergies, sore throats or less energy that makes them feel sick. In order to treat the sickness, usually a person would take a cold medicine or tea to relieve her of whatever is ailing her. However, the cost of the medicine may be prohibitive and often-times the medicine may provide little or no relief from the cold, sneezing, or coughing. Further, the medicine may help to relieve the cold, sneezing or coughing but it may cause another ailment for the person. Thus, there is a need for a trouble-free method to treat a cold, sneezing or coughing that will the person's ailments.

### SUMMARY OF THE INVENTION

The present invention has been accomplished in view of the above-mentioned technical background, and it is an object of the present invention to provide a method for healing a sickness.

In a preferred embodiment of the invention, a method of healing sickness is disclosed. The method includes: providing saffron, date seed powder, olive oil, black seeds oil, hemp oil, and pure honey, mixing the saffron, date seed powder, olive oil, black seeds oil, hemp oil and pure honey to form a first mixture; settling the mixture for a plurality of days; mixing the mixture to form a second mixture; and pouring the second mixture into a container.

### BRIEF DESCRIPTION OF THE DRAWINGS

These and other advantages of the present invention will become more apparent as the following description is read in conjunction with the accompanying drawings, wherein:

FIG. 1 is a flow chart of a method of making a person well in accordance with the invention.

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit, the scope of the invention.

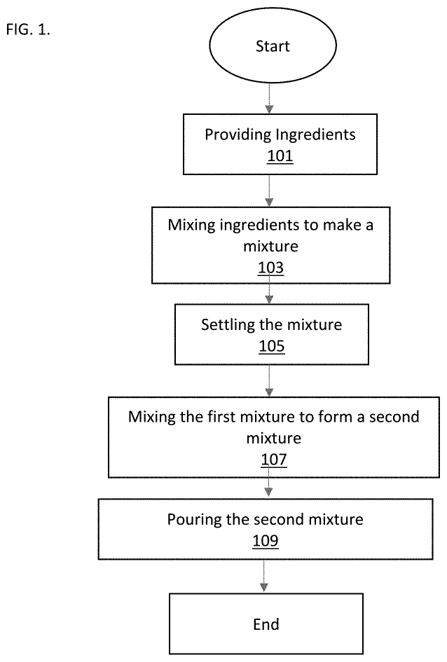

FIG. 1 shows a flow chart of a method of making a person well. A person obtains saffron powder, date seed powder, olive oil, black seeds oil, hemp oil, pure honey, ginger powder, Arabic gum and sesame paste at block 1. The amount of saffron powder is anywhere from 1 to 2 grams, preferably 1 gram. The amount of date seed powder is 1-2 ounces, preferably 2 ounces. The amount of olive oil is 1-2 ounces, preferably 2 ounces. The amount of black seed oil is about 2-3 ounces, preferably 3 ounces. The amount of hemp oil is 1-2 ounces, preferably 2 ounces. The amount of pure honey is 1-2 ounces, preferably 2 ounces. The amount of ginger powder is 1 ounce or 28.3 grams. The amount of Arabic gum is 5 grams. The amount of sesame paste is 2 ounces or 56.7 grams.

Next, at block 103 the aforementioned ingredients saffron, date seed powder, olive oil, black seeds oil, hemp oil and pure honey and mixed together to form a mixture. The ingredients are mixed in a standard kitchen machine for at least 2 hours for 2,000 turns. At block 105, the mix can settle for a few days approximately 3-4 days.

Next, at block 107 the mixture is mixed again to form a second mixture or final mixture. This second mixture is again mixed for at least 2 hours for 2,000 turns on a standard kitchen mixing machine. At block 109, the second mixture is poured into a container where this second mixture can be used to help a person feel better where this entire final mixture is placed in a jar. The person takes a teaspoon full of the final mixture from the jar then within 5 seconds to 30 seconds she feels better, and the sickness is relieved.

A teaspoon of the final, mixture was analyzed and the following measurements were found:

| | Per 100 g | Per serving | Daily value (DV) |
|---|---|---|---|
| Calories | 403 | 25 | 1% |
| Calories from Fat. | 155 | 10 | 0% |
| Total Fat | 17.24 g | 1 g | |
| Saturated Fat | 24% of fat | 0 g | |
| Monosaturated Fat | 52% of fat | 0.5 g | |
| Polyunsaturated Fat | 24% of fat | 0 g | |
| Trans Fat | 0% of fat | 0 mg | 0% |
| Cholesterol | 1 mg | | |
| Moisture | 4.85 g | | |
| Ash | .77 g | | |
| Sodium | 6.80 mg | 0 mg | |
| Total Carbohydrate | 74.21 g | 4 g | 0% |
| Dietary Fiber | 30.5 g | 2 g | 1% |
| Total Sugars | 31.4 g | 2 g | 7% |
| Added Sugars | 31.4 g | 0 g | |
| Protein | 2.78 g | 0 g | 4% |
| Calcium | 35.8 mg | 0 mg | |
| Iron | 3.64 mg | .2 mg | 0% |
| Potassium | 363 mg | 20 mg | 0% |
| Vitamin D | 0 mcg | 0 mcg | 0% |
| Vitamin A | 0 mcg | 0 mcg | 0% |
| Vitamin C | 0 mg | 0 mg | |

This invention provides a simple natural method for treating a sickness. A person can take the all-natural mixture that isn't cost prohibitive where she is able to simple, easily and effectively relieve sickness in a very short period and go about her life.

Although the present invention has been described above in terms of specific embodiments, many modifications and variations of this invention can be made as will be obvious to those of ordinary skill in the art, without departing from its spirit and scope as set forth in the following claims.

What is claimed is:

1. A method of treating sickness comprising:
providing saffron powder, date seed powder, olive oil, black seeds oil, hemp oil, pure honey, ginger powder, Arabic gum and sesame paste;
mixing the saffron powder, date seed powder, olive oil, black seeds oil, hemp oil, pure honey, ginger powder Arabic gum and sesame paste to form a first mixture;
settling the first mixture for a plurality of days;
mixing the first mixture to form a second mixture; and
pouring the second mixture into a container.

2. The method of claim 1, wherein the saffron powder, date seed powder, olive oil, black seeds oil, hemp oil, pure honey, ginger powder, Arabic gum and sesame paste are mixed together in a standard kitchen mixing machine.

3. The method of claim 1, wherein an amount of the saffron powder is 1 gram.

4. The method of claim 3, wherein an amount of the date seed powder is 2 ounces.

5. The method of claim 4, wherein an amount of the olive oil is 3 ounces

6. The method of claim 5, wherein an amount of the hemp oil is 2 ounces.

7. The method of claim 6, wherein an amount of the pure honey is 2 ounces.

8. The method of claim 1, wherein the first mixture is mixed at least 2,000 turns.

9. The method of claim 1, wherein the second mixture is mixed at least 2000 turns.

10. The method of claim 1, wherein the first mixture is mixed by a standard kitchen mixing machine.

11. The method of claim 1, wherein the second mixture is mixed by a standard kitchen mixing machine.

12. The method of claim 1, wherein an amount of the ginger powder is 1 ounce.

13. The method of claim 1, wherein an amount of the Arabic gum is 5 grams.

14. The method of claim 1, wherein an amount of the sesame paste is 2 ounces.
